(19) United States
(12) Patent Application Publication
(10) Pub. No.: US 2024/0293943 A1
(43) Pub. Date: Sep. 5, 2024

(54) TOOL ATTACHMENT FOR A COLLABORATING ROBOT FOR LABORATORY OPERATION

(71) Applicant: bAhead GmbH, Hamburg (DE)

(72) Inventors: Rainer TREPTOW, Norderstedt (DE); Hauke HELLER, Hamburg (DE)

(21) Appl. No.: 18/039,135

(22) PCT Filed: Dec. 1, 2021
(86) PCT No.: PCT/EP2021/083738

§ 371 Date: May 26, 2023

(30) Foreign Application Priority Data
Dec. 7, 2020 (DE) 102020132525.8
Dec. 7, 2020 (DE) 102020132526.6
Dec. 7, 2020 (DE) 102020132529.0

(51) Int. Cl. B25J 15/00

(52) U.S. Cl. CPC B25J 15/0052; B25J 15/009

(57) ABSTRACT

The invention relates to a tool attachment (70) for a collaborating robot. According to the invention, the tool attachment (70) comprises two pairs of gripping jaws (74, 75), the respective gripping jaws of the one pair (74) being arranged at a smaller base distance and those of the other pair (75) being arranged at a larger base distance with respect to one another when moved together.

The invention relates to a tool attachment for a collaborating robot for operating devices. A collaborating robot comprises a handling arm and a base by way of which the robot can be mounted to a worktop. The invention in particular relates to a workstation comprising such a robot in a laboratory so that hereafter mainly a laboratory is addressed, without any limitation being intended to be associated therewith.

In today's age, a plurality of samples must be examined every day in a laboratory. Laboratory systems in which the individual examinations are carried out fully automatically or semi-automatically are known. Nonetheless, the handling of the samples is time-consuming, and at times also problematic, since only certain or standardized sample containers can be used for fully automatic operation. These sample containers are frequently still opened manually and placed into the laboratory instrument. A portion of the sample is taken and is examined and analyzed in the relevant instrument. The examination result is logged. The sample and the origin thereof, for example a patient, are known so that the examination result can be assigned to the sample, and thus to the patient. As a result, a fully automatic laboratory system is generally feasible.

However, the local circumstances in a laboratory, the availability of the individual laboratory devices, and also an integration of existing, and in part very expensive, laboratory equipment in general poses problems. It is always necessary to take certain samples to certain laboratory equipment so that the examinations can be carried out. An existing older laboratory device, however, cannot be readily automated. Here, the sample still has to be manually placed into the device. This process is time-consuming, cost-intensive, and also susceptible to errors.

For a fully automatic laboratory operation, ultimately all required laboratory equipment must be present at a workstation and able to be operated by a control unit. Nonetheless, the samples must be inserted into the relevant device. Due to differing receiving units of the devices, automation is not readily possible due to the variety.

The variety of the sample vessels that are used or employed represents another problem. The samples to be treated are taken to the laboratory in differing vials having differing opening mechanisms. For example, vials or Falcon tubes having screw tops or flip-top lid closures are known. It is also possible to use differing fixtures or trays. Finally, it is known to employ microtiter plates to examine multiple samples. This plurality of vessels on the one hand and of laboratory devices on the other hand likewise makes it more difficult to automate a laboratory operation.

Relief in this regard can be provided by teachable handling robots, which are able to handle a wide variety of objects. Such handling robots can thus remove sample containers having a wide variety of designs from a carrier, open them, and specifically and precisely position them in a different location. Such handling robots are known as collaborative robots, or cobots, and do not require any further explanation per se. These are teachable robots that can be specifically adapted to certain requirements and tasks. However, collaborate robots only have a small operating range and can only exert low forces since they also cooperate directly with a human subject. Known cobots, for example, have an operating range of 300 mm to 400 mm.

Accordingly, smaller, and thus cost-effective, handling robots only have a limited operating range. In particular, the space behind the robot is not accessible for the handling arm thereof. Within the operating range, the robot can generally reach any location and exert a certain force onto an object. At larger forces, for example when opening sample vials, the vial has to be taken to the vicinity of the base of the robot since higher forces are possible there.

Due to the limited operating range of such a typically single-arm robot, it is generally not possible for all laboratory and examination devices to be present at a laboratory workstation. Accordingly, only a certain selection of laboratory devices can be assigned to each handling robot.

Furthermore, a problem during the use of such cobots is that some laboratory devices, for example centrifuges, can only be loaded from above. In particular in the case of larger centrifuges, the machine wall is so tall that the handling arm of the handling robot cannot reach over the wall. However, sometimes it is a matter of only a few centimeters, which nonetheless represent an insurmountable obstacle for the robot.

To solve this problem, it is provided according to the invention that the base can be mounted on a pedestal on the worktop. As a result of the pedestal, the robot is situated at a distance above the worktop. This gives the handling arm a higher articulation point, and the handling arm can thus also reach higher areas at the workstation. In particular, the robot, with the handling arm thereof, is able to reach over higher delimiting walls of devices to be operated by the robot. In this way, the robot can also load centrifuges. The height of the pedestal can be 5.0 cm to 15.0 cm, for example.

The invention takes advantage of the fact that the handling arm is also effective beneath the base. Previously, this space was cut off by the worktop. By raising only the base, this space in front of and beneath the level of the platform of the base continues to be accessible by the handling arm. As a result, the accessible operating range is increased.

Moreover, it may be expedient if the pedestal is composed of multiple disks so that the height of the pedestal can be adapted to the devices present at the relevant workstation. In this way, particularly tall devices can be arranged at a workstation around the robot, which sits on a pedestal raised by the disks. For this purpose, a disk can comprise a mount on the bottom side thereof, which fits in the receptacle on the top side of the pedestal. A corresponding receptacle is present on the top side of the disk. It is then possible to place multiple disk on top of one another and to connect these to one another. It is also possible, of course, to provide such disks between the base and the worktop. The arrangement can thus be flexibly adapted to a wide variety of conditions. The disks can each have a height of 3.0 cm to 10.0 cm. For example, so-called dovetail guides are suitable for a joint that is easy to handle, but nonetheless exact.

According to a preferred embodiment of the invention, the pedestal is designed as a machine shoe, which can be inserted and is held in corresponding rails on the worktop. A dovetail joint is also expedient here. The machine shoe can be detachably connected to the rails. In this way, it is possible to easily switch the robot without time expenditure. It is also possible in a simple manner to install the robot at a different workstation using different laboratory devices.

Here, the advantage of the pedestal or machine shoe becomes particularly apparent. The machine shoe allows the robot to be detachably attached to the worktop using simple means. All that is needed is to remove the robot, together with the machine shoe, from the one rail guide so as to thereafter be inserted into the rail guide at a different workstation. The robot then automatically assumes the correct position at the workstation. Furthermore, a rechargeable battery can be present in the machine shoe so as to at least maintain the power supply of the robot while the robot changes to a different workstation. In this way, a time-consuming new initialization of the robot after changing the workstation is dispensed with. Each workstation can be provided with an identifier, by way of which the robot, after changing the workstation, recognizes which devices are arranged on the worktop and where. The robot is then ready for use again quickly after changing the workstation.

Furthermore, it is expedient when the machine shoe is mounted so as to be movable back and forth in the rails. This further increases the operating range of the handling arm. In particular, it is possible to shift the working range of the robot in the depth of the worktop. It is thus possible to arrange multiple laboratory devices behind one another in the working depth on the worktop, to which the robot can move. A workstation can thus be equipped with a multiplicity of laboratory devices, which can be operated by a robot.

The machine shoe can comprise a dedicated drive for the displacement along the rails. However, it is also possible that the machine shoe can be moved back and forth along the rails by the robot. For this purpose, it is expedient when points of engagement for the handling arm of the robot are arranged at the worktop and/or at the rails. The robot, with the handling arm thereof, can then maneuver itself to the desired location of the rails, and thus of the workstation.

It is generally favorable in this regard when the machine shoe can be locked in predefined positions at the rails. The robot is thus always given a defined position relative to a laboratory device, which the robot can then operate and/or load well.

It may be provided that the pedestal comprises a storage station for tool inserts for the handling arm in front of the base and within reach of the handling arm. The tools that are required for the workstation and for the operations to be carried out thereon then always remain easily reachable for the handling arm and are moved, together with the robot, back and forth on the rails. It is thus possible to change the tools quickly and regardless of the position of the robot on the worktop. Furthermore, it is expedient when a charging station is present in the pedestal, by way of which the tool inserts accommodated in the storage station can be charged using a dedicated power supply.

The fact that the robot can be mounted quickly at other workstations is another advantage. The reason is that the tools in the storage station at the machine shoe or pedestal are always located in the same position relative to the robot. Another initialization or training of the robot in terms of the new workstation environment is thus dispensed with. Additionally, it is not necessary to keep all tools available at the workstations. Rather, one set of tools is sufficient, which is carried along, together with the machine shoe, when the robot changes the workstation.

It is particularly expedient when a rechargeable battery is provided in the machine shoe, which supplies the robot with power, at least while the robot changes the workstation. A new initialization due to an interrupted power supply is thus dispensed with.

It may also be provided that the base of the robot is mounted on the pedestal so as to be rotatable about a vertical axis of rotation. In this way, the robot can also turn toward a laboratory device for better operation of the same. Additionally, the region behind the robot becomes accessible due to the handling arm.

It may also be expedient when at least one inclined chute is present, the upper end of which is located within reach of the handling arm behind the robot and the lower end of which is located behind the robot outside the worktop. This chute can be used to easily dispose of waste or packing material and consumables. The robot usually sits on the pedestal at the front edge of the worktop of a work table. The region in front and to the side thereof is easily accessible. The region behind the robot remains accessible for wiring harnesses and human operators. In general, this is also where the aisle for the operators is located.

It may thus be provided that a waste container, which is easy to empty when needed, is present in the aisle behind each robot beneath the bottom end of the chute. Space on the worktop for the waste is not required. A respective chute can be provided on each side of the robot, which open into different waste containers. In this way, sorting, for example according to contaminated special waste and according to packaging material, can then already take place in advance. Such tasks can be readily carried out by a cobot.

Through the use of such a raised pedestal, which can be displaced in the depth direction, for the handling robot, the operating range overall is thus successfully increased, and in particular for the intended operations. The complexity for this is low, and this can be implemented cost-effectively.

Another problem when employing such handling robots is that these, in general, only comprise one handling arm, at the free end of which a gripper comprising two gripping jaws is arranged. Even though in this way a plurality of operations can be carried out, some simple operations are not possible since the second “hand”, serving as a counter bearing, is missing. This relates, for example, to the opening of sample vials. However, for the automated laboratory operation, it is necessary that the sample containers are opened and also closed again.

According to the invention, it is provided that at least one receptacle, into which a sample container fits and in which the container is held, at least against horizontal forces, is present on the worktop in the operating range of the handling robot. As a result, the sample container can initially be removed from a transport holder by the handling robot and placed into the receptacle. The handling robot can then embrace and open the closing lid by an appropriate movement and, for example, place the same on a defined support surface at the workstation in a defined position. After the sample has been removed, the same lid can be grabbed again and attached. An unambiguous assignment is thus possible, and a sample container is always closed with the same lid.

Such a placement can be dispensed with when the lid remains connected to the sample container after opening. This is the case, for example, with the flip-top lid containers from Eppendorf AG, DE-22339 Hamburg, the so-called ‘Eppis’, in which the lid is connected to the container by way of a tab. This tab can also serve orientation purposes, the handling robot having to pry open the lid from the side of the tab which faces away.

At times, relatively high forces are needed when opening a sample container since the lids are also sealingly attached to the sample container by way of a detent closure. It is therefore furthermore provided according to the invention that the receptacle is designed as a depression in which the sample container fits. The cross-section and the dimensions of the receptacle can be adapted to the contour and the dimensions of the sample container in such a way that the sample container is essentially held without play in the receptacle. The depth of the depression can be 50% to 90% of the height of the sample container. As a result, the sample container, which is frequently designed as an elongated sample vial, does not tilt out of or is not lifted out of the receptacle during the opening movement. Due to the play-free mount, the sample container is additionally given a defined position relative to the workstation. In this way, it can be securely opened by the handling robot. Nonetheless, the lid remains clear and easily accessible. The depression can be provided in the worktop or in a pedestal on the worktop. In both instances, a sample container present therein can be easily reached by way of the handling arm of the robot.

It is frequently necessary during laboratory operation to open a plurality of identical sample containers, and also to close these again. If only one receptacle were present, the automated opening would take relatively long since each sample container must be placed into the individual receptacle.

Flip-top lid containers are frequently used with such multiple samples, in which the lid is captively held at the sample vial by way of a strap. The strap also forms the hinge about which the lid must be pivoted. According to the invention, the receptacle comprises a front rod and a rear rod, between which at least one sample container fits, and preferably multiple sample containers fit, next to one another such that the tab faces the rear rod. The front rod extends beneath the lid on the side of the sample container facing away from the strap. The rear rod extends above the lid on the side of the sample container facing the strap. The length of the rods is dimensioned such that these protrude laterally next to the sample container.

When the receptacle is filled, multiple sample containers are situated between the rods, wherein the tab for lifting the lid projects beyond the front rod. It is then possible for a tool to be grabbed by the handling robot, the tool comprising a beam that has two open hooks at the lateral ends thereof. With these hooks, the beam can be rotatably hooked either to the front rod or the rear rod on the side next to the containers by the handling robot. The rods thus serve as pivot bearings for the pivoting movement that the beam carries out.

For opening the containers, the beam is hooked from above with the hooks into the rod and then folded upwardly. The opening of the hook points downwardly in the process. Depending on the width of the hook in the direction away from the rod, the force for opening the flip-top lid is accordingly larger or smaller so that the flip-top lids can be reliably opened. In particular, it is possible in this way to open multiple sample containers simultaneously.

For closing the flip-top lids, the beam is hooked from behind into the rear rod. The opening of the hook likewise points downwardly or away from the container. The pivot point thus formed is located above the center of rotation of the hinge, so that pivoting of the beam downwardly in the direction toward the container causes the flip-top lid to be moved in the direction toward the container opening. There, the container sealingly engages with a sealing lip. As a result, it is also possible to close a plurality of containers quickly and securely.

Accordingly, the sample container is only placed into the receptacle and held there in a form-locked manner. Sample containers in which the lid is designed as a screw top are also known. The handling robot is also not able to open these using only one handling arm. The sample container is only held in the receptacle against horizontally acting forces, not, however, against rotational movements.

According to the invention, it is provided here that clamping means are present in the receptacle, which clamp the inserted sample container in place in the receptacle. In this way, the sample container is also held against twisting at the workstation so that the rotational movements for opening and closing the twist top can be carried out by the handling robot.

The clamping means can comprise clamping jaws that can be moved with respect to one another and clamp the sample container between one another. In particular, it can be provided that the clamping jaws hold the sample container in place with a predefinable contact pressure. In this way, it is also possible to securely hold delicate sample containers. It is then also possible to hold sample containers of differing sizes in the receptacle.

It is advantageous when one of the clamping jaws is stationary and forms a reference surface. In this way, the position of the sample container relative to the receptacle is established, so that the sample container can be securely grabbed or opened by the handling robot.

Furthermore, it is expedient when the clamping jaws have elastic and/or flexible clamping surfaces, which rest against the sample container. As a result, the clamping jaws conform to different shapes of the sample containers. This also achieves particularly secure and tilt-proof retention in the receptacle.

If the sample container is open, at least a fraction of the sample can be taken. For this purpose, the sample container can remain in the receptacle. An additional movement of the sample container is thus not required. It is easily possible for a handling robot to take a sample from the sample vial using a pipette, for example.

However, the handling robot must know the height up to which the sample vial is filled so as to insert the pipette the appropriate distance. Another problem is that at least two layers are present in the sample vial in the case of centrifuged samples, and the sample to be examined must be taken from either the top layer or the bottom layer. It is therefore necessary to specify to the handling robot how far the robot may or must dip the pipette tip into the sample container.

According to the invention, at least one camera is present in the receptacle for the sample container, by way of which the interfaces of the individual layers of the sample contained therein can be detected. The camera can, for example, include a perpendicularly oriented line sensor, which extends along the height of the sample container. It is then possible to reliably pick up the position and the height of a boundary layer.

Generally, the camera at the handling robot can also be used for detecting the interfaces. Artificial intelligence connected to and usable with the camera can help detect the interfaces easily. It is also possible for the robot to turn the sample vial if a label impedes light from passing through. In particular, no additional costs arise for a separate camera. The receptacle must have a see-through or transparent wall or be made of such a material, so that the camera held in front of the same can record the interfaces. The receptacle is then preferably arranged above the worktop.

The invention here takes advantage of the fact that the sample vials or containers are generally transparent. The sample contained therein and the interfaces thereof are thus easily visible. It is furthermore provided that a strip-shaped light source is present, which transilluminates the sample container along the vertical extension thereof. In this way, the interfaces, and in particular the height thereof relative to a reference surface, can be rendered easily visible for the camera.

For example, three layers are present in a blood sample after centrifugation. The cruor collects at the bottom. Above that, there is the serum, above which an air layer is present, up to the lid. The serum in particular is needed for examination purposes. It is therefore necessary for the pipette tip to be dipped exactly into the central layer in order to take a sample.

The interface between the cruor and the serum can be detected relatively easily due to the contrast between the two layers. The interface between the serum and the air can be detected by different scatter effects, even though the air layer hardly differs from the serum in terms of color. The light passing through is scattered differently by a section of a vial that is filled with liquid than when passing through a section filled with air. This can be easily picked up by the camera. Overall, appropriately designed image processing allows the interfaces to be established with sufficient accuracy. The detected image signal of the camera is converted into height information in terms of how far the handling robot should dip the pipette into the sample container to be able to take a sample from the desired layer.

The image signal can moreover be used to recognize an empty sample vial or to determine the liquid volume. In the first case, the examination can be aborted by way of a corresponding error message.

Due to the versatility of an above-described handling robot, many tasks can be carried out automatically. In particular due to the arrangement of a storage station for the tool attachments at the machine shoe, the interchangeable tools are always held in the same location and easily accessible for the handling arm. Additionally, the tools move together with the machine shoe, so that no additional displacement movements of the handling robot are required for changing the tools.

However, it is not always possible to push simple operating buttons of a laboratory device by way of a gripper, which is the customary tool for such a handling robot. This, however, is necessary for the operation of laboratory devices that cannot be integrated into a network.

It is therefore the object of the invention to create a tool attachment for a collaborating robot which can be used to operate any device.

To achieve this object, the invention provides that at least one tool is present, which can be connected to the handling arm of the handling robot and which, at the free end thereof, has a pin-shaped protrusion by way of which press buttons, push buttons or levers or slide controllers of a laboratory device can be actuated. Using simple means, this replaces the finger of a human subject by a pin, which can be moved by the handling robot and directed at an operating element so as to actuate the same. The automated operation of a device that is not integrated into the laboratory controller is possible in this way.

It is also possible for a gripping jaw of the gripper to be provided with a pin-shaped protrusion. The protrusion can project transversely to the gripper longitudinal direction, for example. A button or push button or switch of a device can then be operated by appropriate pivoting of the gripper, after which the pin-shaped protrusion points at the switch, button or push button to be operated. The advantage here is that no tool change is required for operating a device.

Furthermore, it is favorable when the pin-shaped protrusion is pivotably mounted at the tool attachment. In this way, the robot can be adapted to different spatial circumstances at the workstation. The angular position only has to be set once for the devices or the operating elements present at the workstation to be reached particularly well. This is in particular expedient when the pin-shaped protrusion is mounted to a tool attachment including other tools. Due to a variable position relative to this tool, the pin-shaped protrusion does not interfere with the other tool, and vice versa.

The tip of the pin or protrusion can comprise a non-slip coating or be made of a non-slip material. This makes it possible to also push smooth or small operating buttons.

Furthermore, a sensor can be present, by way of which effective depression of the operating button is recognized. A successful actuation of an operating button is frequently accompanied by an engagement sound or an acoustic signal. This engagement sound or acoustic signal can be detected by the sensor so as to abort the actuation process or to repeat the actuation process if it should be necessary to actuate the operating element multiple times. As an alternative or in addition, the force that is required for depression can be ascertained and programmed.

Frequently, a successful actuation of an operating button is only visually displayed or shown on a display. The handling arm of the handling robot can be equipped with a camera, by way of which such optical signals can be recognized. The relevant operating button can then be actuated until the desired value or the desired function of the laboratory device has been set. Such monitoring and recognition of optical signals or displays can be readily carried out using known image processing systems.

It is expedient in any case to provide a camera at the handling arm so that the positions of the sample vials and also of the labels thereof can be detected. In this way, the path of the sample can always be comprehensibly logged.

As a result of such a tool attachment, it is also possible to use laboratory devices in an automated laboratory operation that do not have any interface to a network, and therefore cannot be integrated. Here, the handling robot takes over for the human hand and operates the relevant device.

The handling of pipette tips that initially have to be placed onto the pipette for taking samples from a sample vial is another problem. This is generally not problematic, even for a robot, since the pipette is inserted together with the receptacle thereof from above into the pipette tip. The pipette tip then engages and can be used. In contrast, the ejection of the pipette tip is problematic since here the pipette has to be held on the one hand, and a trigger has to be actuated on the other hand.

In some pipettes, the pipette tip is ejected by depression of an ejector button, which has to be moved beyond a pressure point for ejection. To this end, the gripper arm that is present on a handling robot and comprises two gripping jaws, which can be moved with respect one another, can be used. For moving the pipette, the gripper arm grabs the pipette such that the ejector button is depressed in the trigger direction to the pressure point. The pipette is then held sufficiently so as to be able to be moved. The force or the distance that is required to move the ejector button to the pressure point is known and can be entered into the handling robot.

The control of the pipette, this being the uptake and the dispensing of the liquid, can be carried out via a network, the central laboratory controller or the workstation controller. For ejecting or placing down the pipette tip, the pipette is moved over the desired location, and the gripper arm moves the one gripping jaw beyond the pressure point, whereby the pipette tip is released.

If a counter bearing for the other gripping jaw of the gripper is missing at the pipette, a counter bearing can be mounted to the pipette in the desired position. It is then possible to firmly and securely grab the pipette by way of the gripper.

During laboratory operation, frequently either individual sample containers that have a round cross-section and a small diameter of, for example, 1.0 cm to 2.0 cm, or wide carriers having a width of, for example, 8.0 cm to 12.0 cm for multiple sample containers are handled. Generally, these objects can be moved by a robot using respective adapted grippers. However, this always makes it necessary to change the tool attachment since the lift or spreading distance of the gripping jaws is limited so that either only the individual containers having a small diameter or the carriers larger in terms of the width can be grabbed. When the gripper is mounted for an individual container, the gripping jaws cannot move far enough apart to seize the carrier at the side. When the gripper is mounted for a carrier, the gripping jaws cannot move far enough together to hold the individual container. In particular, this gripper remains open even when moved together.

It is provided in this regard for the tool attachment to comprise two pairs of gripping jaws, the gripping jaws of one pair being arranged at a smaller base distance and those of the other pair being arranged at a larger base distance with respect to one another. The base distance is in each case dimensioned so that individual containers, for example a vial, can be easily grabbed by way of the one pair of gripping jaws. Here, the base distance is small and can also be zero. The carriers can be held and moved securely by way of the other pair of gripping jaws. The base distance here is large and can be 8.0 cm, for example. The lift is the same for both pairs, and both pairs are always moved simultaneously. Depending on what object is to be grabbed, one of the two pairs of gripping jaws faces the object, while the respective other pair of gripping jaws grabs nothing.

It is furthermore provided that the pairs are arranged at spaced-apart, and in particular opposite, ends of the tool attachment. The tool attachment then only has to be rotated for changing the active pair of gripping jaws so that the suitable pair of gripping jaws can grab the corresponding object. A rotation is readily possible by way of the handling arm of the robot.

The free ends of the respective gripping jaws or the braces supporting the gripping jaws can advantageously also be adjusted. In this way, the gripping jaws can be held at the handling arm of the robot in any angular position, that is, axially, perpendicularly or at an angle between 0° and 90° with respect to the axis of rotation of the tool holder. In this way, this tool attachment comprising multiple grippers can be adapted well to the local circumstances. The respective effective surfaces of the gripping jaws facing one another can be provided with non-slip coating. This enables secure grabbing of the relevant objects.

With such a tool attachment comprising grippers on both sides, the respective gripping jaws are no longer concentric to the axis of rotation of the tool holder of the robot. Multiple revolutions of the gripping jaws about this axis of rotation, such as are necessary for opening a twist top, can therefore no longer be readily carried out. It is provided in this regard to design a clamping region concentrically to the axis of rotation of the tool holder at the tool attachment, which can be opened and closed together with the gripping jaws. The clamping region can be provided with a non-slip coating on the effective surfaces facing one another. This prevents the lid from slipping during rotation.

In general, the robot has an adjustable threshold of the force with which the gripping jaws are pressed together. This force threshold can be set so that sealing closure of the sample container is ensured when closing the twist top.

The invention will be described in greater detail hereafter based on the schematic drawings. In the drawings:

FIG. 1 shows the side view of a workstation arrangement according to the invention;

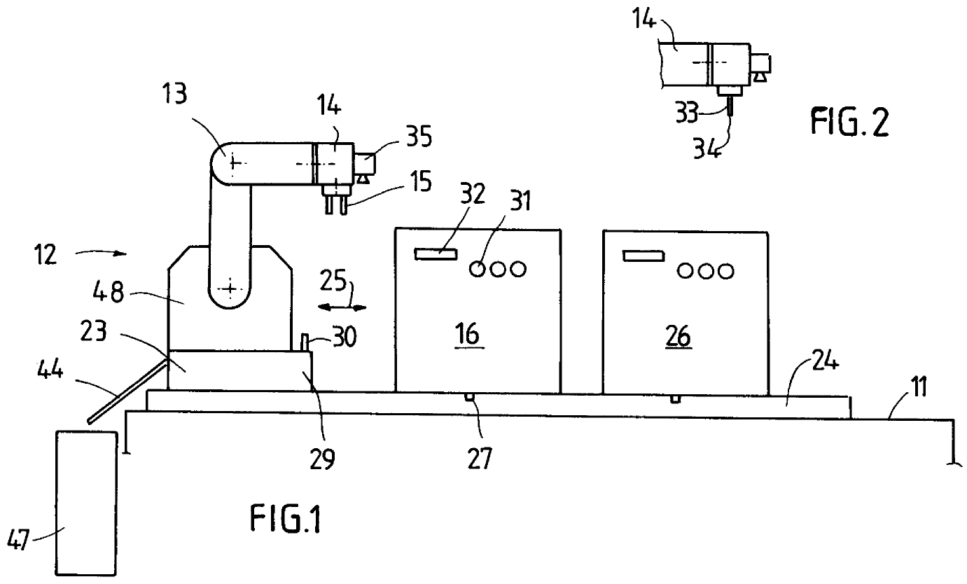

FIG. 2 shows the free end of a handling arm of a handling robot comprising an interchangeable tool;

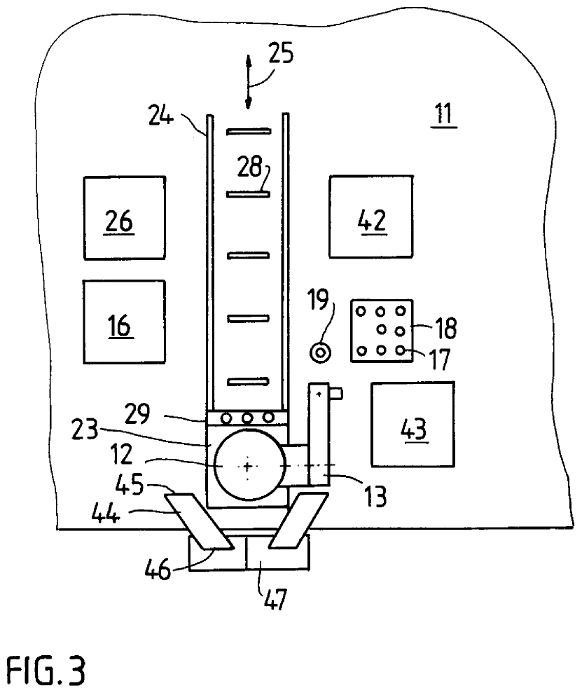

FIG. 3 shows the top view onto the workstation arrangement;

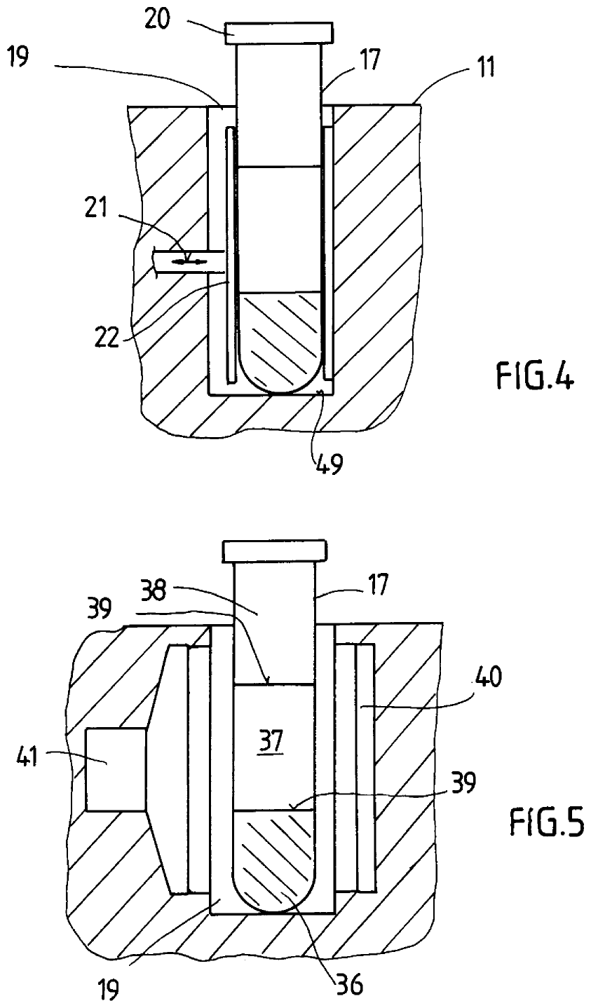

FIG. 4 shows a longitudinal sectional view through a receptacle for a sample container at the workstation;

FIG. 5 shows a different longitudinal sectional view through the receptacle according to FIG. 4;

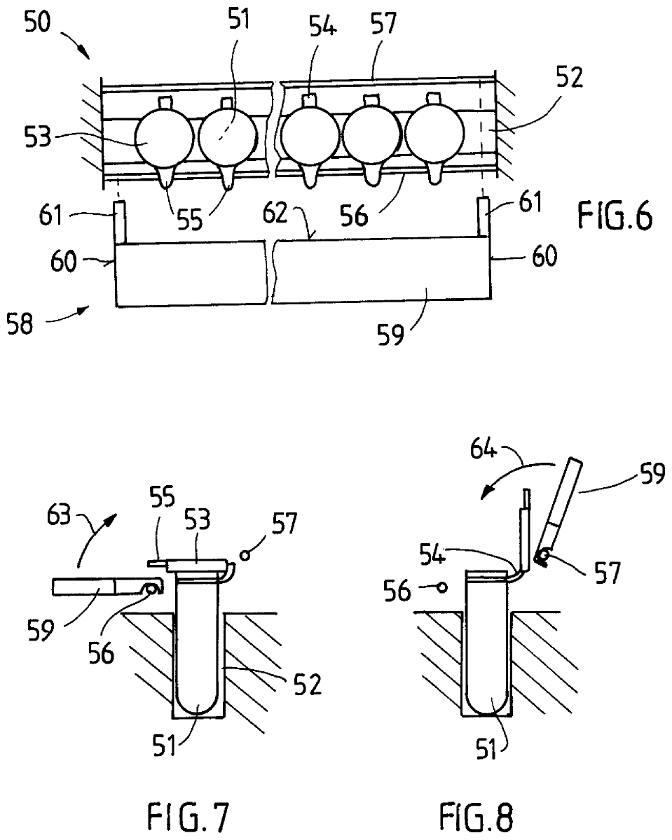

FIG. 6 shows the top view onto a receptacle for multiple sample containers;

FIG. 7 shows the side view of the receptacle according to FIG. 6 when opening the sample containers partially in a sectional view;

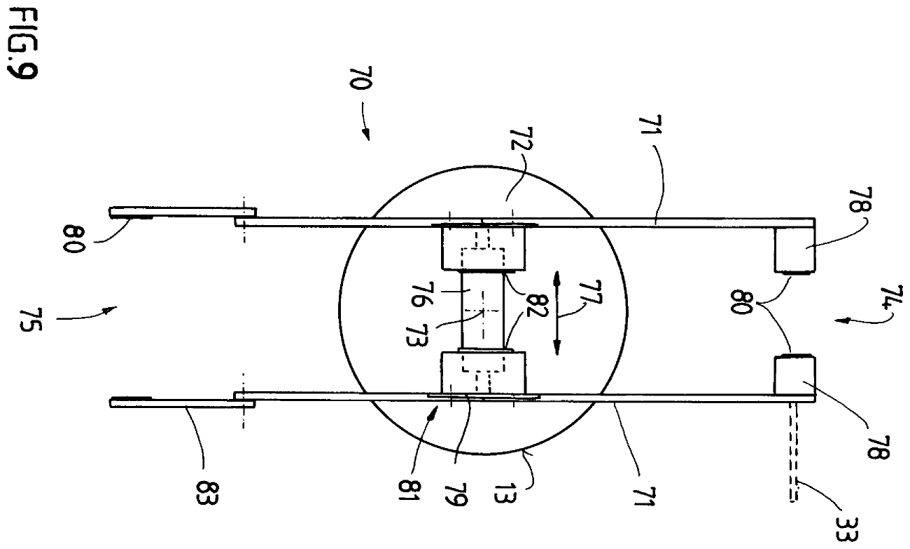

FIG. 8 shows the side view of the receptacle according to FIG. 6 when closing the sample containers partially in a sectional view; and

FIG. 9 shows the top view onto a tool attachment comprising multiple gripping jaws.

The workstation arrangement shown in the drawings is present on a worktop 11 of a work table in a laboratory and includes a collaborating handling robot 12 comprising a base 48 with which the handling robot is standing on the worktop 11. The handling robot 12 is equipped with a multi-member handling arm 13 in the manner known per se, at the free end 14 of which a tool attachment, for example a gripper 15 comprising two gripping jaws that can be moved with respect to one another, is rotatably mounted. The individual members of the handling arm can be rotated with respect to one another. As a result of this arrangement, the handling robot can reach virtually any location within the operating range thereof and can pick up, move and place objects using the gripper 15. A handling robot is known in this respect and does not require any further explanation.

The workstation comprises multiple devices 16 which can be used to treat the samples to be examined. The laboratory devices are known per se and likewise do not require any further explanation. For an automated laboratory operation, it is necessary that the samples to be examined are inserted into the laboratory device and removed. Sample containers, in general sample vials 17, are provided for this purpose, which are stored in a rack 18 and made available to the workstation. The handling robot 12 takes a sample vial 17 from the rack 18 and places it into a receptacle 19 at the workstation. In the receptacle 19, the sample vial 17 is held securely against horizontally acting forces. The sample vial 17 can be held substantially without play in the receptacle 19. The lower bottom 49 of the receptacle 19 on which the sample container 19 sits can be designed as a screen or be provided with a drain opening so that potentially leaking sample liquid can drain, and the sample vial can be inserted without resistance.

The sample vial 17 is closed by a lid 20, which must be opened for removing a sample. The receptacle 19 provides sufficient retention for this due to the depth thereof when a flip-top lid is involved. This lid can be opened, and for example placed down, by a corresponding movement and/or configuration of the tool attachment 15. If a twist top is involved, the sample container 17 must be secured to prevent rotation so that the lid 20 can be unscrewed. For this purpose, clamping jaws 22, which can be moved back and forth in the direction of the double arrow 21 and clamp the sample container 17 between one another and thus hold it securely to prevent rotation, are present in the receptacle 19. In this way, the sample container 17 can be opened by way of the single-arm handling robot 12. A rotational movement can be readily carried out by way of the gripper 15 of the handling robot 12.

The handling robot 12 is designed as a collaborating robot and therefore has small dimensions. The operating range of the handling arm 13 thereof is accordingly small and is only approximately 300 mm to 400 mm. So as to increase the gripping height, a pedestal 23 is provided, which in the exemplary embodiment shown in the drawing is designed as a machine shoe that is guided and held on rails 24, which are mounted on the worktop 11. Generally, it is also possible to provide only one rail, for example having a dovetail joint.

As a result of the pedestal 23, the robot 12 is raised so that the working height thereof is increased. This increase is sufficient to be able to reach over a device wall of a laboratory device 16 so as to place a sample or a sample vial therein. The worktop 11 and, for example, the sample vial recessed in the receptacle 19 nonetheless remain easily accessible for the handling arm 13.

Furthermore, the pedestal 23, and thus the handling robot 12, can be moved back and forth along the double arrow 25 on the rails 24. This increases the operating range thereof in the depth direction of the workstation, so that laboratory devices 26 located further away are also accessible for the handling robot 12. Detent marks 27 can be present, so that the handling robot can assume a defined position relative to the laboratory device 16, 26. The pedestal 23 can comprise a dedicated drive or be pulled or pushed by the handling robot 12 along the rails 24. Gripping points 28 are provided along the rails 24 for this purpose, at which the gripper 15 can hold on for displacement. Such processes can be readily carried out by way of a handling robot.

In the front region, the pedestal 23 can comprise a storage station 29 for tool attachments 30, which are thus carried along and are easily accessible for the robot. A tool change can be carried out by the handling robot 12 itself.

Furthermore, it can be provided that a charging station for tools that require a dedicated power supply is present at the storage station. The charging of the rechargeable batteries of the relevant tool can be carried out inductively, for example.

The tools can be held magnetically at the storage station or at the handling arm of the robot. The tools can also have an engagement section into which the gripping jaws of the gripper fit. As a result, changing the tools is possible particularly easily since the gripper only has to engage with the gripping jaws in the engagement section. There, the gripper can be closed or opened so as to rigidly connect the tool to the handling arm.

The laboratory devices 16, 26 can, for example, comprise an interface to the central workstation controller. It is then readily possible to integrate such devices into an automated laboratory operation. Frequently, however, the devices comprise no, or no suitable, interface to be operated by a workstation controller. A conventional control panel comprising multiple operating buttons 31 is present, which are easy to actuate by human operators. Furthermore, a display 32 is frequently present, on which the status of the laboratory device 16, 26 is shown.

So as to be able to integrate also such devices into an automated laboratory operation, the handling robot 12 can be equipped with a tool designed as a pin 33. Similarly to a human finger, this pin 33 can actuate the operating buttons 31 so that the desired functions of the laboratory device 16, 26 can also be set by the handling robot 12. The free end 34 of the pin can be provided with an elastic and non-slip layer. The collaborating handling robot 12 can learn the positions of the operating buttons 31 and how to actuate them. Turning knobs can be actuated by way of the gripper. The display 32 or other signaling units at the laboratory device can be read by a camera 35 attached to the handling arm 13 so as to receive feedback for the actuation of an operating button 31. Such sequences of movements can be entered into a collaborating robot.

The pin 33, however, can also be arranged at the gripper 15 and, for example, project laterally from the gripping jaws. Furthermore, it is possible that the pin is present at the gripper 15 so as to be extendable. When not in use, it can then be retracted and does not interfere with the sequences of movements.

In some laboratory devices, only a fraction of a sample is examined, which must be taken from the sample container 17. Pipettes are customary for this purpose, which are dipped into the sample liquid to take the sample amount. In the case of a blood sample, in general three layers are present in the sample vial 17 after centrifugation, namely cruor 36 at the bottom, followed by the layer 37 including the serum, and finally the air layer 38. For the handling robot to hit the middle layer 38 including the serum with the pipette tip, the position or height of the interfaces 39, and thus the immersion depth of the pipette tip must be detected and ascertained.

For this purpose, an optical detection system is provided in the receptacle 19, which comprises a strip-shaped light source 40 and a line-shaped, light-sensitive sensor 41 located opposite thereof. The sample vial 17 is transilluminated, and the positions of the interfaces 39 can be detected. Since the geometries are known, the pipette tip can, for example, be dipped exactly into the layer 37 containing the serum.

FIGS. 6 to 8 show a receptacle 50 in which like and equally sized sample containers 51 can be placed next to one another. The receptacle 50 includes a trough-shaped channel 52, having a width that is preferably slightly larger than the diameter of the sample container 51. The sample container 51 is designed as flip-top lid container, which can be closed by a lid 53 that is hinged on one side to the container 51 by a flexible and bendable hinge strap 54. This hinge strap 54 thus forms a hinge. For opening the lid 53, a tab 55, by way of which the lid 53 can be lifted relatively easily while the container 51 is held in place, is present on the side opposite the hinge strap 54. Such containers 51 are generally known and therefore do not require any further explanation.

The receptacle 50 includes a front rod 56, which extends above and laterally next to the channel 52 in such a way that the tab 55 of the container 51 inserted into the channel 52 extends above the rod 56. The receptacle 50 furthermore comprises a rear rod 57, which extends laterally and above the channel 52 so as to extend behind and above the hinge strap 54 of the container 51 inserted into the channel.

As is shown in FIG. 6, the containers 51 can be inserted into the receptacle next to one another and so as to be uniformly aligned. Accordingly, all tabs 55 extend over the front rod 56. The positions and the lengths of the front rod 56 and the rear rod 57 are selected so as to protrude laterally next to the terminal containers 51.

The tool 58 for opening the containers 51 present in the receptacle 50 includes a beam 59, which can be grabbed well by the handling robot 12. On the one longitudinal side 62 thereof, the beam 59, at the lateral edges 60 thereof, comprises a respective hook 61, which is open on one side and points away from this longitudinal side. These hooks 61 can be hooked into the lateral protrusions of either the front or rear rod 56, 57. The beam 59 is thus mounted at the receptacle 50 so as to pivot about a pivot axis. The inside dimension between the hooks 61 along the longitudinal side 62 is larger than the total width of the containers 51 placed into the receptacle 50.

For opening the containers 51, the beam 59 is placed with the hooks 61 thereof from above onto the front rod 56, with the openings of the hooks pointing downwardly, as shown in FIG. 7. Upwardly pivoting the beam about the pivot axis formed thereby in the direction of the arrow 63 causes the lids 53 to be pried open simultaneously. The lids 53 then remain in an upright position. The containers 51 are held securely in the channel 52 in the process.

For closing the containers 51, the beam 59 is rotated so that the hooks 61 can be placed, with the openings thereof pointing in the other direction, from above into the rear rod 57. This situation is shown in FIG. 8. Another pivot axis is formed for the beam 59. Pivoting the beam 59 about this pivot axis downwardly in the direction of the arrow 64 causes all the containers 51 to be closed again by the lids 53 thereof.

The movements required for opening and closing can be readily carried out by the handling robot 12 and the gripper 15 thereof. Due to the positions of the rods 56, 57 and thus of the pivot axes relative to the container 51, the forces of the handling robot 12 that can be applied are sufficient to open or close multiple lids simultaneously. In this way, it is possible to rapidly process a plurality of sample containers.

FIG. 9 shows another tool attachment 70 for holding differently sized objects. The tool attachment 70 comprises two parallel braces 71, which are attached to the tool holder 72 of the handling arm 13 so as to be movable with respect to one another. This movement corresponds to the lift movement of the gripper 15 by way of which the gripping jaws can be opened and closed. The lift, however, is limited so that the gripping jaws of the gripper 15 shown in FIG. 1 can only be moved back and forth by a certain distance.

On the tool attachment 70, the braces 71 extend perpendicularly to the axis of rotation 73 of the tool holder 72. At the opposing sides of the braces 71, a respective pair of gripping jaws 74, 75 is formed. The braces 71 can be moved toward and away from one another in the direction of the double arrow 77 by a lift mechanism 76, which is not shown in greater detail. In the closed position of the lift mechanism 76, the braces 71 are still spaced apart at a distance in the region of the axis of rotation 73.

The one pair of gripping jaws 74 is arranged on inwardly directed protrusions 78 of the braces 71. In the closed position of the lift mechanism 76, the gripping jaws 74 are therefore located closely together or on top of one another so that individual containers having small dimensions can be securely grabbed. The other pair of gripping jaws 75 on the other side of the braces 71 is either formed directly at the free ends of the braces 71, or the free ends of the braces 71 widen. In this way, it is possible to securely grab wider objects, such as carriers. The respective lift for grabbing or releasing the relevant objects is the same for both pairs of gripping jaws 74, 75.

The gripping jaws are provided with non-slip coatings on the effective surfaces 80 thereof facing one another. Furthermore, the free ends of the braces 71 can be angled and/or exchanged so as to adapt the gripping jaw pairs 74, 75 to the respective local circumstances of the workstation. For this purpose, the free ends of the braces 71 of the gripping jaw pair 75 are designed as extensions 83 that are attached to the braces 71 in an articulated manner. It is also possible for the braces 71 to be divided and pivotably mounted to a carrier 79 in the region of the axis of rotation 73. In this way, the gripping jaw pairs 74, 75 can be held at the braces 71, which in the side view of FIG. 9 project from the tool holder 72 in a V-shaped manner, wherein the tip of the V is held at the carrier 79. It is then possible to change the engaging gripping jaws 74, 75 by rotating the tool holder about the axis of rotation 73. The unused gripping jaws pair 74, 75 is then located outside the effective range of the other gripping jaw pair 75, 74 and does not interfere with the operation thereof.

On the tool attachment 70, the center region of the braces 71 is additionally designed about the axis of rotation 73 as a clamping region 81. Here, the mutually opposing effective surfaces 82 can also be provided with a non-slip coating. The effective surfaces 82 can also be arranged on protrusions extending axially with respect to the axis of rotation 73. This approach takes advantage of the fact that the tool holder 72 is able to rotate at the handling arm 13 by 720° or more. As a result, it is thus also possible to open or close twist tops of a container using this central clamping region 81.

It is also possible for the pin 33 to be arranged in a suitable location at this tool attachment 70, which projects laterally from a free end of a gripping jaw of the pair 74, for example parallel to the lift movement 77. The pin can also be held pivotably at the gripping jaw. This pin is shown with dotted lines in FIG. 9.

In this way, a multifunctional tool is provided. The one pair of gripping jaws 74 can be used to handle individual sample containers. The other pair of gripping jaws 75 is used to move carriers. The central clamping region 81 can be used to actuate twist tops. The lateral pin 33 allows laboratory devices to be operated. A time-consuming change of the tool attachment between two process steps is then no longer required.

Furthermore, a storage station 42 for consumables and a storage station 43 for the racks 18 for the sample vials 17, which are accessible to the handling robot 12, can be present at the workstation. Used material or other waste must be removed from the workstation. Lateral chutes 44 are provided for this purpose next to the pedestal 23, the upper end 45 of which is still located within the operating range of the handling arm 13 of the handling robot 12. The bottom end 46 facing away from the handling robot 12 opens into a waste container 47. The waste can then be picked up by the handling robot 12 and placed onto the chute 44, from where the waste reaches the waste container 47. In this way, the otherwise unusable dead space behind the handling robot 12 is utilized well. By providing a divided waste container 47, different types of waste can be separately disposed of via the two chutes 44. This assignment is readily possible using a teachable collaborating robot 12.

The collaborating robot 12 can recognize and grab, as well as handle and place down, any objects within the operating range thereof. For secure grabbing, the relevant object must be held on the worktop 11 with a certain level of adhesion so as not to slide away when grabbed by the gripper. It can therefore be provided that the worktop 11 around the handling robot 12 is provided with an adhesive coating, which achieves a certain level of adhesion with an object sitting thereon. The objects are then secure in the predetermined position on the worktop 11 and can be securely grabbed. The coating can be formed by an adhesive mat, for example, which is installed in front of and to the side of the handling robot on the worktop 11 of the workstation.

Furthermore, it can be provided that regions that are predefined for certain objects or for certain work processes are provided on the worktop 11, which are identified, for example, by a frame or a legible marking. The handling robot can then find an object placed thereon more easily by way of the camera and determine the orientation thereof for handling. For this purpose, the mat can be accordingly printed in advance, regardless of the workstation.

Another advantage when using such an adhesive mat is that the mat is generally made of a compliant material. As a result, vibrations of the handling robot are damped and not transferred to the devices and objects situated on the mat. In this way, an object is prevented from being inadvertently moved on the worktop 11.

1. A tool attachment for a collaborating robot (12), characterized in that the tool attachment comprises two pairs of gripping jaws (54, 55), the gripping jaws of the one pair (54) being arranged at a smaller base distance and those of the other pair (55) being arranged at a larger base distance with respect to one another when moved together.

2. The tool attachment according to claim 1, characterized in that the pairs (54, 55) of gripping jaws are arranged at spaced-apart ends of the tool attachment.

3. The tool attachment according to claim 2, characterized in that the pairs (54, 55) of gripping jaws are arranged at opposite ends of the tool attachment.

4. The tool attachment according to claim 3, characterized in that at least one pair (54, 55) of gripping jaws is mounted on braces (51).

5. The tool attachment according to claim 4, characterized in that the free ends of the respective gripping jaws (54, 55) or the braces (51) carrying the gripping jaws are adjustable.

6. The tool attachment according to claim 5, characterized in that a clamping region (61) is designed concentrically to the axis of rotation (53) of the tool holder at the tool attachment, which can be opened and closed together with the gripping jaws.

7. The tool attachment according to claim 6, characterized in that a pin-shaped protrusion (33) is provided to actuate operating buttons (31) of a device, and in particular of a laboratory device (16, 26).

8. The tool attachment according to claim 7, characterized in that the pin-shaped protrusion (33) is arranged at the tool attachment so as to be extendable.

9. The tool attachment according to claim 8, characterized in that the pin-shaped protrusion (33) is held at the tool attachment so as to be pivotable about at least one axis.

10. The tool attachment according to claim 9, characterized in that the force with which the gripping jaws can be moved together and with which the gripping jaws are held in the effective position thereof, in which the object is grabbed, can be adjusted.

11. The tool attachment according to claim 1, wherein the pairs (54, 55) of gripping jaws are arranged at opposite ends of the tool attachment.

12. The tool attachment according to claim 1, wherein at least one pair (54, 55) of gripping jaws is mounted on braces (51).

13. The tool attachment according to claim 1, wherein the free ends of the respective gripping jaws (54, 55) or the braces (51) carrying the gripping jaws are adjustable.

14. The tool attachment according to claim 1, wherein a clamping region (61) is designed concentrically to the axis of rotation (53) of the tool holder at the tool attachment, which can be opened and closed together with the gripping jaws.

15. The tool attachment according to claim 1, wherein a pin-shaped protrusion (33) is provided to actuate operating buttons (31) of a device, and in particular of a laboratory device (16, 26).

16. The tool attachment according to claim 15, wherein the pin-shaped protrusion (33) is arranged at the tool attachment so as to be extendable.

17. The tool attachment according to claim 16, wherein the pin-shaped protrusion (33) is held at the tool attachment so as to be pivotable about at least one axis.

18. The tool attachment according to claim 1, wherein the force with which the gripping jaws can be moved together and with which the gripping jaws are held in the effective position thereof, in which the object is grabbed, can be adjusted.
